(19) United States
(12) Patent Application Publication
(10) Pub. No.: US 2014/0192284 A1
(43) Pub. Date: Jul. 10, 2014

(54) Gradient Index Liquid Crystal Optical Device and Image Display Device

(71) Applicant: KABUSHIKI KAISHA TOSHIBA, TOKYO (JP)

(72) Inventors: AYAKO TAKAGI, YOKOSUKA-SHI (JP); SHINICHI UEHARA, TOKYO (JP); MASAKO KASHIWAGI, YOKOHAMA-SHI (JP)

(21) Appl. No.: 14/203,423

(22) Filed: Mar. 10, 2014

Related U.S. Application Data
(63) Continuation of application No. PCT/JP2011/071218, filed on Sep. 16, 2011.

(51) Int. Cl. G02B 27/22; G02F 1/29

(52) U.S. Cl. CPC G02B 27/2214; G02F 1/29
USPC 349/15; 349/139

(57) ABSTRACT

According to one embodiment, an optical device includes a first substrate, a second substrate arranged to face the first substrate, a liquid crystal layer, first electrodes, second electrodes, a third electrode, and fourth electrodes. The first electrodes are provided on the first substrate on a side of the liquid crystal layer and extends in a first direction. The second electrodes are arranged between the first electrodes and extend in the first direction. The third electrode is provided on the second substrate on the side of the liquid crystal layer and extends in a third direction. The fourth electrodes are arranged between the first and second electrodes and extend in the first direction. The second electrodes adjacent in a second direction are electrically connected, and the fourth electrodes adjacent in the second direction are electrically connected.

### CROSS REFERENCE TO RELATED APPLICATIONS

This application is a Continuation application of PCT Application No. PCT/JP2011/071218, filed Sep. 16, 2011, the entire contents of all of which are incorporated herein by reference.

### FIELD

Embodiments described herein relate generally to a gradient index liquid crystal optical device and an image display device.

### BACKGROUND

Display devices capable of displaying a 3D (three-dimensional) image have conventionally been proposed. There is a demand of implementing two-dimensional (2D) image display and three-dimensional (3D) image display selectively using a single display device, and techniques for meeting the requirement have been proposed.

For example, JP-A 2000-102038 (KOKAI) describes a technique of switching 2D display and 3D display using a liquid crystal lens array element. This liquid crystal lens array element includes bar-like electrodes periodically arranged on one substrate. An electric field distribution is formed with respect to electrodes formed on a counter substrate. The electric field distribution changes the orientation of a liquid crystal layer and generates a refractive index distribution functioning as a lens. The lens function can be turned on/off by controlling voltages to be applied to the electrodes. Hence, 2D display and 3D display can be switched. The method of controlling the orientation direction of liquid crystal molecules by an electric field is called a GRIN (GRadient INdex) lens method. In this arrangement, when voltages to obtain 3D display or 2D display are applied to the bar-like electrodes, 2D display and 3D display can be switched partially in a direction in which the bar-like electrodes are arrayed.

Additionally, for example, JP-A 2004-258631 (KOKAI) describes an arrangement that provides polarization variable cells independently of a liquid crystal lens array element. According to this arrangement, the polarized state of light entering the liquid crystal lens array element is switched in the display surface, thereby partially switching 2D display and 3D display.

Furthermore, for example, JP-A 2007-226231 (KOKAI) describes a technique of, in a liquid crystal GRIN lens, extending the wirings of upper and lower electrodes in directions almost perpendicular to each other in the vertical and horizontal directions, thereby performing orientation switching display. The functions of a power supply and ground are electrically switched in each of the upper and lower substrate electrodes of a liquid crystal GRIN lens, thereby enabling orientation switching.

In the 2D/3D display switching display described in JP-A 2000-102038 (KOKAI), however, the bar-like electrodes are arrayed only in the horizontal direction. As a result, switching between 2D display and 3D display can be done in a full screen. Switching between 2D display and 3D display is also possible partially in the horizontal direction. However, the division cannot be done in the vertical direction.

In the display described in JP-A 2004-258631 (KOKAI), the division can be done not only in the horizontal direction but also in the vertical direction. However, since polarization variable cells are necessary in addition to the liquid crystal GRIN lens element, the thickness and weight increase, and the cost rises.

In the display described in JP-A 2007-226231 (KOKAI), since each of the upper and lower electrodes also serves as a ground surface, the electrodes are arranged all over so as to narrow the gaps. There is no mention of an electrode structure necessary for partial 3D display.

### BRIEF DESCRIPTION OF THE DRAWINGS

FIG. 1 is a perspective exploded view showing a 3D image display device according to an embodiment in a case in which first to fifth electrodes exist.

FIG. 2 is a perspective plan view of a first substrate shown in FIG. 1.

FIG. 3 is a perspective plan view of the first substrate in a case in which first to fourth electrodes exist.

FIG. 4 is a perspective plan view of a second substrate shown in FIG. 1.

FIG. 5 is a sectional view taken along a line B-B′ in FIG. 2 at the time of 3D display.

FIG. 6 is a view showing a liquid crystal director distribution when an electrode structure and voltage application for enabling a lens function are used in a lens shown in FIG. 5.

FIG. 7 is a graph showing an average refractive index distribution and an ideal refractive index distribution in the thickness direction which are calculated from the liquid crystal director distribution shown in FIG. 6.

FIG. 8 is a sectional view when no voltage is applied to the electrodes along the line B-B′ in FIG. 2.

FIG. 9A is a sectional view taken along a line C-C′ in FIG. 4 and a line C″-C′″ in FIG. 2 at the time of 3D display.

FIG. 9B is a sectional view when no voltage is applied to the electrodes along the line C-C′ in FIG. 4 and the line C″-C′″ in FIG. 2.

FIG. 9C is a view showing a liquid crystal director distribution when an electrode structure and voltage application for enabling a lens function are used in a lens shown in FIG. 9A.

FIG. 10 is a perspective plan view of a first substrate in a case in which first to sixth electrodes exist.

FIG. 11 is a sectional view taken along a line D-D′ in FIG. 10.

FIG. 12 is a graph showing the positions of electrodes and their voltage values in a case in which first to fifth electrodes exist according to the embodiment.

FIG. 13 is a graph showing the positions of electrodes and their voltage values in a case in which first to fifth electrodes exist according to the embodiment, and the central position of the fifth electrode is closer to the lens center than in FIG. 12.

FIG. 14 is a view showing a voltage waveform applied to perform partial 3D display in the 3D image display device shown in FIG. 1 and a flag bit corresponding to the voltage.

FIG. 15 is a table showing an example representing the flag bits of addresses and columns when the voltage shown in FIG. 14 is applied and the presence/absence of implementation of 3D display.

FIG. 16 is a table showing another example representing the flag bits of addresses and columns when the voltage shown in FIG. 14 is applied and the presence/absence of implementation of 3D display.

FIG. 17 is a graph showing the relationship between crosstalk at the time of 2D display and (V_{c}−V₀)/(V₁−V₀) where v_{c} is the counter voltage applied to a plurality of third electrodes on a second substrate in the table of FIG. 16.

FIG. 18 is a graph showing the relationship between the ratio of the maximum luminance to the minimum luminance at the time of 2D display and (V_{c}−V₀)/(V₁−V₀) where v_{c} is the counter voltage applied to a plurality of third electrodes on a second substrate in the table of FIG. 16.

FIG. 19 is a perspective plan view showing a liquid crystal lens array element according to the second embodiment in which a first direction and a second direction are not perpendicular, which is configured to implement partial 3D display having a shape close to a rectangle, viewed from the liquid crystal layer side of a first substrate.

FIG. 20 is a perspective plan view showing a second substrate configured to implement partial 3D display having a shape close to a rectangle in FIG. 19.

FIG. 21 is a view showing an example representing the specification form of a 3D image display device according to an embodiment.

### DETAILED DESCRIPTION

A gradient index liquid crystal optical device and an image display device according to an embodiment and, more particularly, a liquid crystal lens array element and a 3D image display device will now be described in detail with reference to the accompanying drawings. Note that in the following embodiments, parts denoted by the same reference numerals are assumed to operate similarly, and a repetitive description thereof will be omitted, as appropriate.

It is an object of the embodiments to provide a gradient index liquid crystal optical device capable of performing orientation switching display by a single lens and also performing partial 3D display, and an image display device.

According to one embodiment, a gradient index liquid crystal optical device includes a first substrate, a second substrate, a liquid crystal layer, first electrodes, second electrodes, a third electrode, and fourth electrodes. The second substrate is arranged to face the first substrate. The liquid crystal layer is sandwiched between the first substrate and the second substrate. The first electrodes are provided on the first substrate on a side of the liquid crystal layer and extending in a first direction. The second electrodes are arranged between the first electrodes and extending in the first direction. The third electrode is provided on the second substrate on the side of the liquid crystal layer and extends in a third direction different from the first direction. The fourth electrodes are arranged between the first electrodes and the second electrodes and extending in the first direction. The second electrodes adjacent in a second direction different from the first direction are electrically connected, and the fourth electrodes adjacent in the second direction are electrically connected.

### First Embodiment

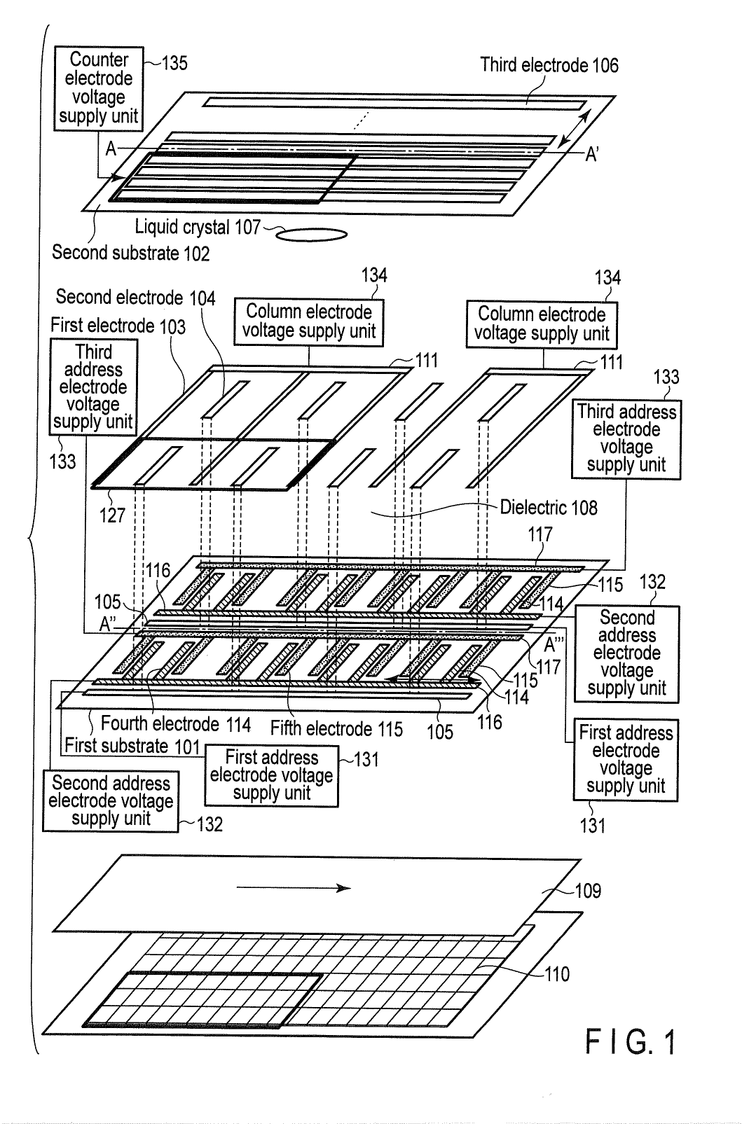

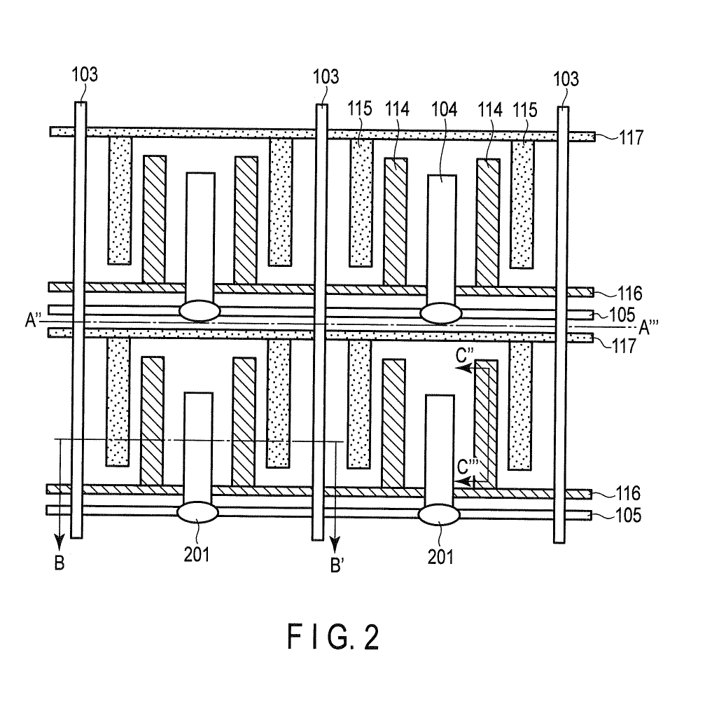

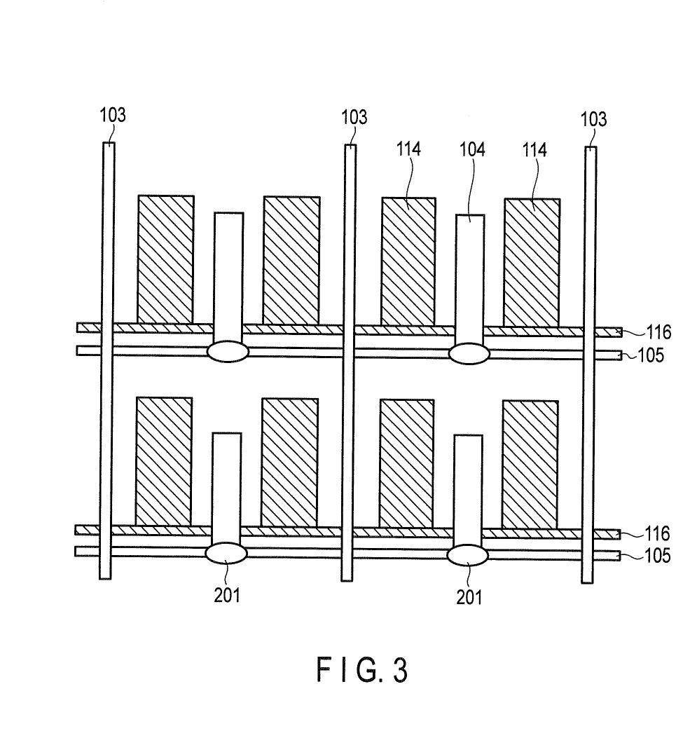

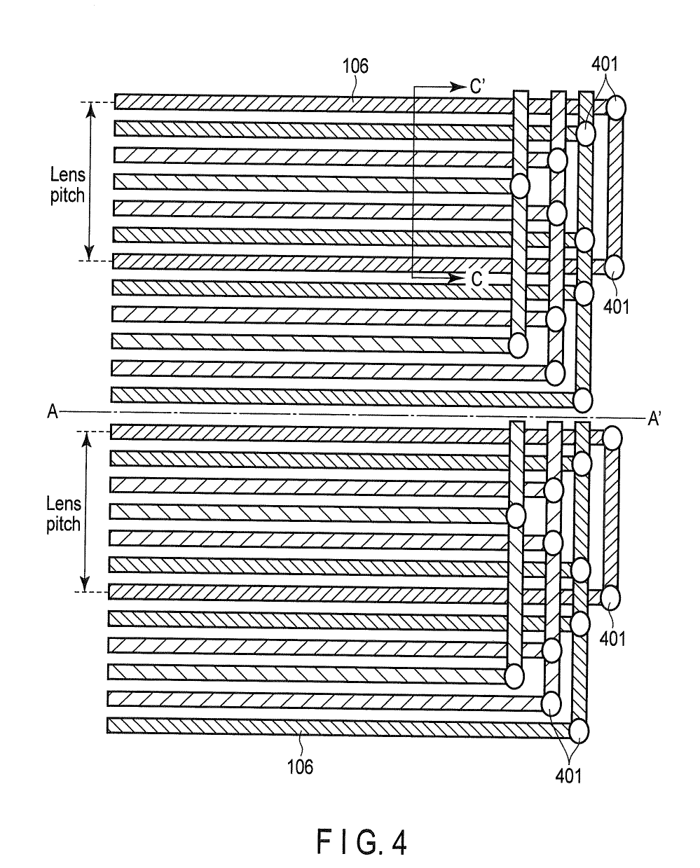

A liquid crystal lens array element and a 3D image display device according to the embodiment will be described with reference to FIGS. 1, 2, 3, and 4. FIG. 1 is a perspective exploded view showing a 3D image display device in a case in which first to fifth electrodes exist. Note that a portion indicated by a double-pointed arrow in FIG. 1 represents a lens pitch (one lens unit). In the drawings to be described later as well, a portion indicated by a double-pointed arrow represents a lens pitch (one lens unit), as in FIG. 1. A portion surrounded by a thick line in FIG. 1 represents one unit region of partial 3D display. FIG. 2 is a perspective plan view from a direction perpendicular to a first substrate. FIG. 4 is a plan view from a direction perpendicular to a second substrate. FIG. 3 is a plan view of the first substrate in a case in which first to fourth electrodes exist. Reference numerals 201 in FIG. 2 and 401 in FIG. 4 denote through holes.

The 3D image display device according to this embodiment includes a first substrate 101, a second substrate 102, first electrodes 103, second electrodes 104, second extraction electrodes 105, third electrodes 106, first extraction electrodes 111, fourth electrodes 114, fifth electrodes 115, fourth extraction electrodes 116, fifth extraction electrodes 117, liquid crystal directors 107, a dielectric 108, a polarizing plate 109, a 2D image display device 110, first address electrode voltage supply units 131, second address electrode voltage supply units 132, third address electrode voltage supply units 133, column electrode voltage supply units 134, and a counter electrode voltage supply unit 135.

The second electrodes 104 and the second extraction electrodes 105 are disposed on the upper and lower sides of an insulating layer formed from the dielectric 108, respectively. Hence, through holes (indicated by dotted lines in FIG. 1) that electrically connect them are formed. The liquid crystal lens array element corresponds to a portion of the 3D image display device except the polarizing plate 109 and the 2D image display device 110, and includes the first substrate 101, the second substrate 102, the first electrodes 103, the second electrodes 104, the second extraction electrodes 105, the third electrodes 106, the first extraction electrodes 111, the fourth electrodes 114, the fifth electrodes 115, the fourth extraction electrodes 116, the fifth extraction electrodes 117, the liquid crystal directors 107, the dielectric 108, the first address electrode voltage supply units 131, the second address electrode voltage supply units 132, the third address electrode voltage supply units 133, the column electrode voltage supply units 134, and the counter electrode voltage supply unit 135.

Each of the first substrate 101 and the second substrate 102 is made of a transparent material and has a flat shape. That is, the first substrate 101 and the second substrate 102 can pass light.

The second electrodes 104 are made of a conductor and extend by a certain length in a first direction on the first substrate 101. The second electrodes 104 are disposed while being divided into a second number of groups. Each group includes a plurality of second electrodes 104. The plurality of second electrodes 104 in each group are electrically connected at ends by the second extraction electrodes 105 in a second direction different from the first direction. The second electrodes 104 connected by one second extraction electrode 105 belong to the same group. As a result, the second electrodes arrayed in the second direction form a group. Note that in this embodiment, the first direction and the second direction are perpendicular to each other. Note that in FIG. 1, the second electrodes 104 and the second extraction electrodes 105 are disposed on the upper and lower sides of an insulating layer, respectively, and therefore electrically connected by through holes configured to electrically connect them.

The dielectric 108 is stacked on the first substrate 101 and the second extraction electrodes 105. The first electrodes 103 are arranged on the dielectric 108 and extend in the first direction. The dielectric 108 is an insulating layer configured to prevent the first electrodes and the second electrodes from being rendered conductive. The first electrodes 103 are disposed while being divided into a first number of groups. Each group includes a plurality of first electrodes 103. The plurality of first electrodes 103 in each group are led out in the second direction and electrically connected at ends by the first extraction electrodes 111. The first electrodes of different groups are not electrically connected.

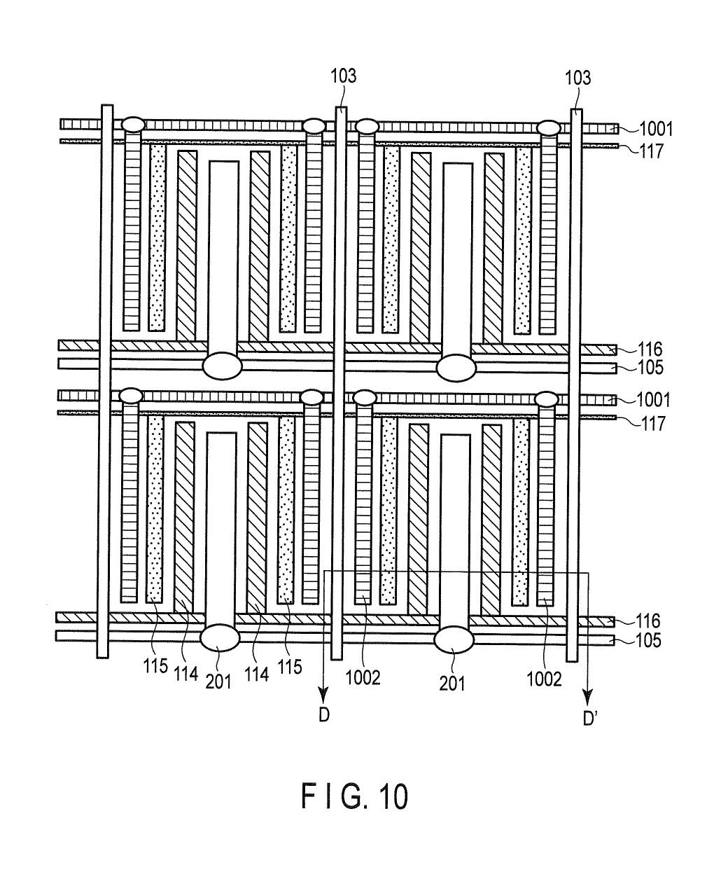

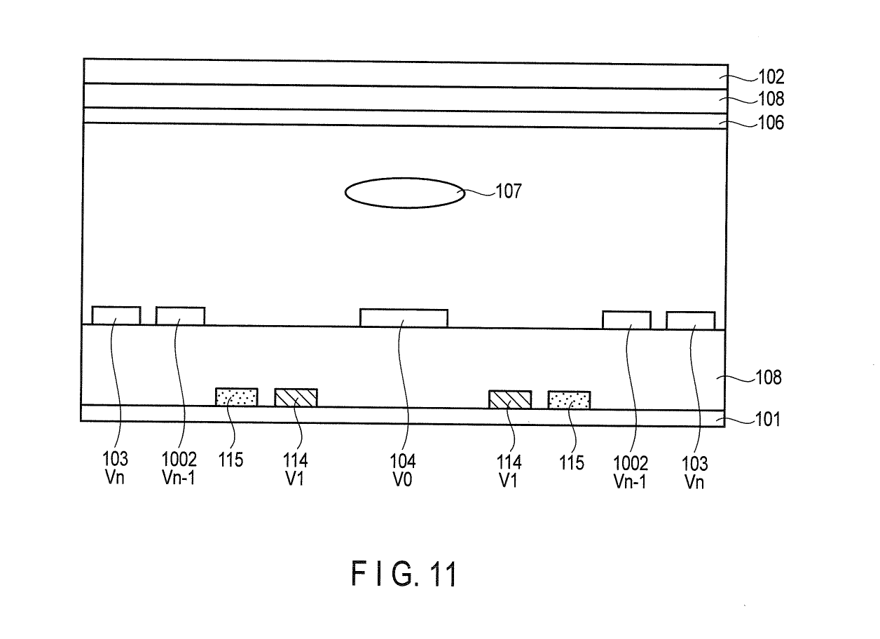

One fourth electrode 114 and one fifth electrode 115 are arranged between one first electrode 103 and one second electrode 104. A pair of fourth electrodes 114 and a pair of fifth electrodes 115 are arranged so as to sandwich one second electrode 104. The number of electrodes arranged between the first electrode 103 and the second electrode 104 is not limited to two, and one electrode (only fourth electrode; see FIG. 3) or three (fourth to sixth electrodes; see FIGS. 10 and 11; 1002 denotes a sixth electrode; and 1001, a sixth extraction electrode) or more electrodes may be arranged. In the example shown in FIG. 1, two electrodes (fourth and fifth) are arranged and divided in the vertical direction, like the second electrodes. The fourth extraction electrodes 116 and the fifth extraction electrodes 117 are led out in the same direction as the second direction of the adjacent second extraction electrodes 105 of the second electrodes and connected to adjacent fourth electrodes 214 and adjacent fifth electrodes 115, respectively, to form groups of equipotential.

The extending direction of the first electrodes 103 and that of the second electrode 104 are the same direction. As for the horizontal-direction positions on the substrate, one second electrode 104 is located at a position (for example, central position) between two adjacent first electrodes 103. That is, the first electrodes 103 and the second electrodes 104 are alternately arrayed in the horizontal direction. In the example shown in FIG. 1, four second electrodes 104 are arranged between five first electrodes 103. Two adjacent first electrodes 103, the second electrode 104, fourth electrodes 114, and fifth electrodes 115 located between the first electrodes 103, and several third electrodes 106 located above the second electrode 104 make a set. A region where a region framed by three first electrodes 103 and several third electrodes 106 overlap is one unit region 127 of partial 3D display. In the example shown in FIG. 1, four unit regions (two regions divided in the vertical direction and two regions divided in the horizontal direction) of partial 3D display exist.

The liquid crystal directors 107 form a liquid crystal that exhibits uniaxial birefringence, and fill the space between the dielectric 108, the first electrodes 103, and the second substrate 102. On the second substrate 102, the third electrodes 106 are stacked on the side of the layer of the liquid crystal directors 107.

The third electrodes 106 are made of a conductor and extend by a certain length in a third direction (same direction as the second direction in FIG. 1) on the second substrate 102. The third electrodes 106 extend in the second direction, for example, from one end of the second substrate 102 to the other end. There exist the third electrodes 106 in a number corresponding to the second number that is the number of groups of the second electrodes 104. For example, seven third electrodes 106 exist in correspondence with one group of the second electrodes 104. The third electrodes 106 are disposed in correspondence with a certain group of the second electrodes 104.

The first address electrode voltage supply unit 131 is electrically connected to the second extraction electrode 105 of each group and the second electrodes 104 located above the second extraction electrode 105. The second address electrode voltage supply unit 132 is electrically connected to the fourth extraction electrode 116 and the fourth electrodes 114 of each group. The third address electrode voltage supply unit 133 is electrically connected to the fifth extraction electrode 117 and the fifth electrodes 115 of each group.

The column electrode voltage supply unit 134 is electrically connected to the first electrodes 103 of each group. The column electrode voltage supply unit 134 sets the connection destinations to a predetermined potential.

The polarizing plate 109 is disposed under the first substrate 101, and the 2D image display device 110 is disposed under the polarizing plate 109. The 2D image display device 110 includes pixels arrayed in a matrix. A device normally used today as a display device can be applied. Note that the arrow on the polarizing plate 109 in FIG. 1 represents the direction of polarization. The 2D image display device 110 may include the polarizing plate 109. Rectangles arranged on the 2D image display device 110 shown in FIG. 1 indicate pixels. In FIG. 1, 18 horizontal pixels and 6 vertical pixels are arranged.

Note that in the example shown in FIG. 1, the first number that is the number of groups of the first electrodes 103 is 2, and the second number that is the number of groups of the second electrodes 104 is 2. The numbers are merely examples, and can appropriately be changed in accordance with the size of the display screen, the size of the region to do partial display, and the like.

“Above” or “upper” expresses a direction perpendicular to the substrate. For example, the second substrate 102 is located above the first substrate 101. In addition, “below” (or “lower”) and “above” (or “upper”) correspond to opposite directions. “Horizontal direction” corresponds to the leftward/rightward direction within a substrate plane and is parallel to, for example, a line A-A′ or a line A″ to A′″ in FIG. 1. “Vertical direction” is a direction perpendicular to the horizontal direction within a substrate plane and is parallel to, for example, a line C-C′ in FIG. 1.

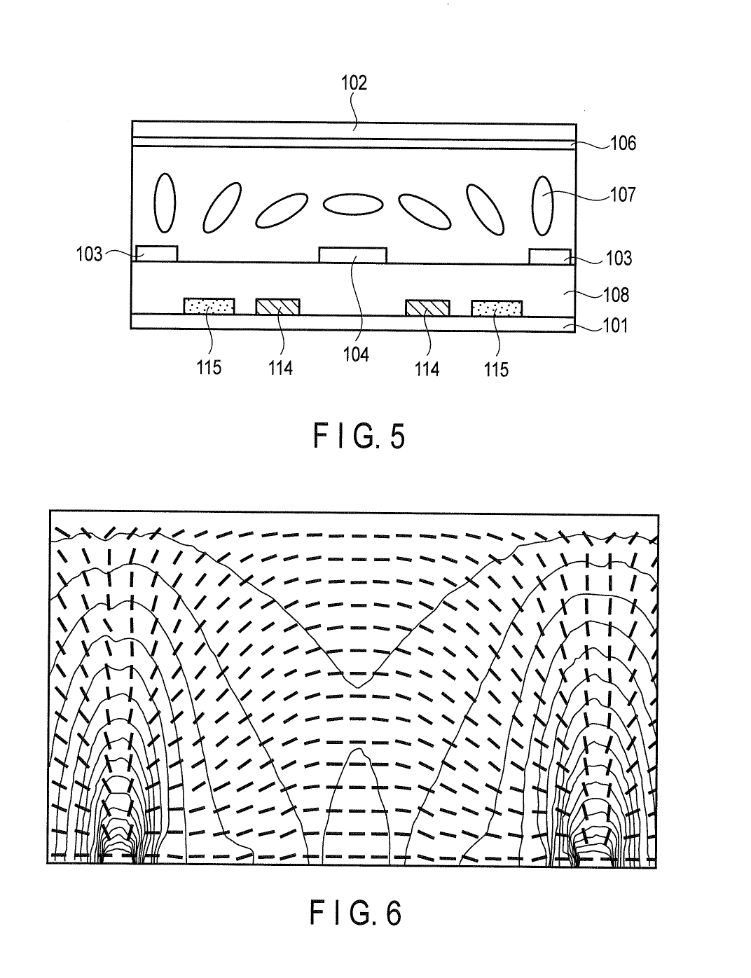

The electrode structure shown in FIG. 1 will be described next with reference to FIG. 5 that is a sectional view taken along a line B-B′ in FIG. 2.

The fourth electrodes 114 and the fifth electrodes 115 are disposed between the first substrate 101 and the insulating layer of the dielectric 108. The first electrodes 103 and the second electrode 104 are disposed between the dielectric 108 and the liquid crystal layer including the liquid crystal directors 107. This can prevent the electrodes from being electrically connected even when crossing upon leading out in the second direction. The electrodes in contact with the liquid crystal layer are the first electrodes 103 which are located at the lens ends and to which a high voltage is applied, and the second electrode 104 which is located at the lens center and to which a ground or low voltage is applied. These electrodes largely affect the gradient distribution of the liquid crystal directors 107. The fourth electrodes 114 and the fifth electrodes 115 take intermediate voltages. Normally, when the fourth electrode 114 or fifth electrode 115 is wide, a predetermined voltage is generated immediately above it, and a smooth change in the potential distribution is impeded. However, when the electrodes are not in direct contact with the liquid crystal layer, a smooth potential distribution can be formed even on the fourth electrodes and the fifth electrodes.

To the plurality of second electrodes 104, the plurality of fourth electrodes 114, and the plurality of fifth electrodes 125 in a group, voltages are applied via the single second extraction electrode 105, the single fourth extraction electrode 116, and the single fifth extraction electrode 117, respectively. For this reason, in the horizontal direction, the same voltages are applied within the range of the length of the leader lines. In the vertical direction, the same voltage is applied by the vertical length of the wires via the through holes.

On the other hand, when all electrodes are placed on the same plane, as in a prior art in FIG. 5, through holes are needed to lead out the respective electrodes, resulting in a decrease in yield as productivity.

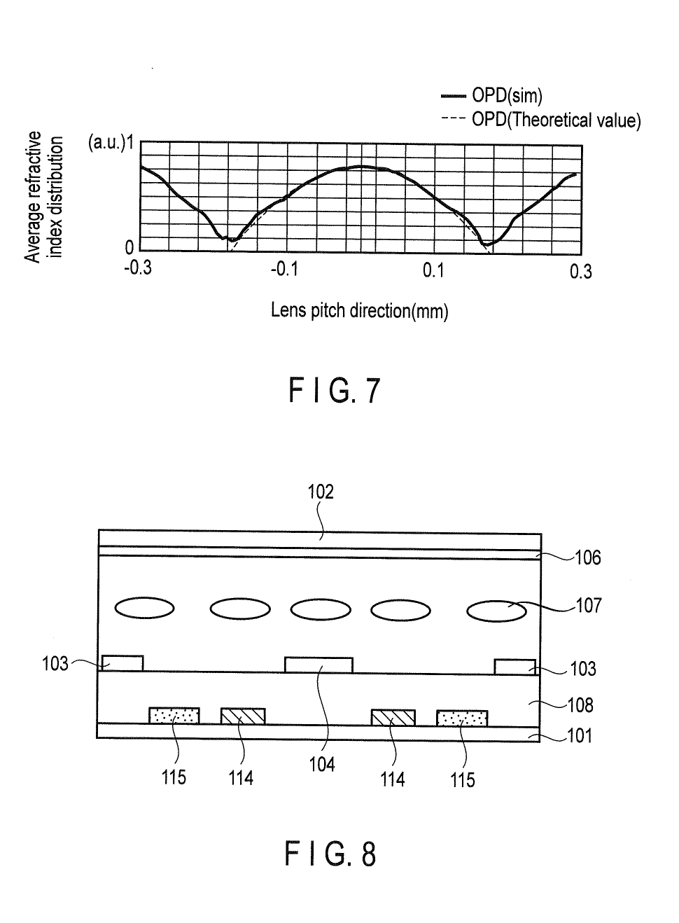

An ideal refractive index distribution of the lens will be described next with reference to FIGS. 6 and 7.

Assuming Y to be a coordinate in the lens pitch direction, Ne a refractive index in the long axis direction of a liquid crystal molecule, No a refractive index in the short axis direction of a liquid crystal molecule, Ne−No the birefringence characteristic of the refractive index of the liquid crystal, and 2Y₀ the pitch of lenses formed from a coordinate −Y₀ to +Y₀, an ideal refractive index distribution is expressed as

$$n ( Y ) = {N}_{e} - ( \frac{{N}_{e} - {N}_{o}}{{Y}_{o}^{2}} ) {Y}^{2} \qquad ( 1 )$$

Since Ne>No, in a uniaxial liquid crystal, when a high voltage is applied to the lens ends, and the voltage is gradually lowered toward the lens center, a gradient index close to equation (1) is obtained.

When the direction of incident polarized light and the liquid crystal director direction, that is, the orientation direction are set to be parallel or perpendicular to each other, in-plane rotation of the combined vector of Ne and No does not occur. For this reason, the refractive index can be controlled only by the gradient distribution of the liquid crystal. Hence, a refractive index distribution close to an ideal refractive index distribution can be obtained.

FIG. 6 shows an electric field distribution and a liquid crystal director distribution when the fourth electrodes 114 and the fifth electrodes 115 are arranged on the lens center sides and lens end sides as auxiliary electrodes. As can be seen, the potential distribution in the lower portion of the liquid crystal is changed by the fourth electrodes 114 and the fifth electrodes 115.

FIG. 7 is a graph showing an average refractive index distribution and an ideal refractive index distribution in the thickness direction which are calculated from the liquid crystal director distribution shown in FIG. 6. A distribution close to an ideal refractive index distribution can be held even when only two types of electrodes, the fourth electrodes 114 and the fifth electrodes 115 are added.

An embodiment in which the 3D image display device is used in a horizontal position has been described above.

There are cases in which parallax light beams are distributed in the horizontal direction using the device as a naked eye 3D image display device placed in a horizontal position, or distributed in the vertical direction using the device as a device placed in a vertical position. For this reason, the upper electrodes are extended in a direction almost perpendicular to the first direction of the lower electrodes. When a lens is formed by applying a desired voltage to the power supply of the upper electrodes, a ground potential or a low reference potential is applied to all electrodes in a corresponding region of the lower electrodes. The reference voltage is applied because the potential need not always equal the ground potential of the circuit, and an electric field distribution needs to be generated by the difference with respect to the upper power supply.

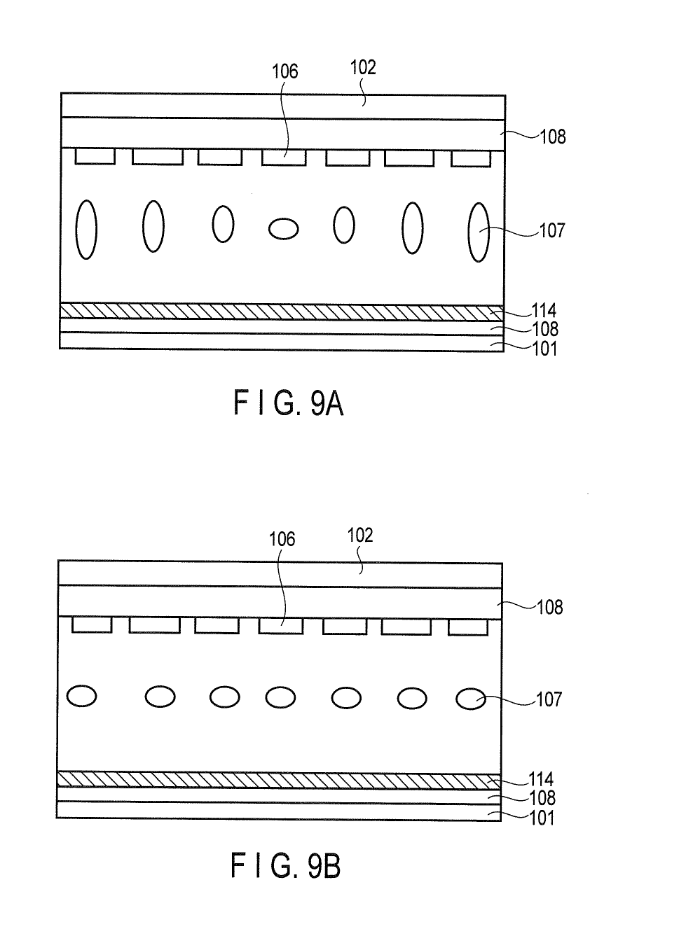

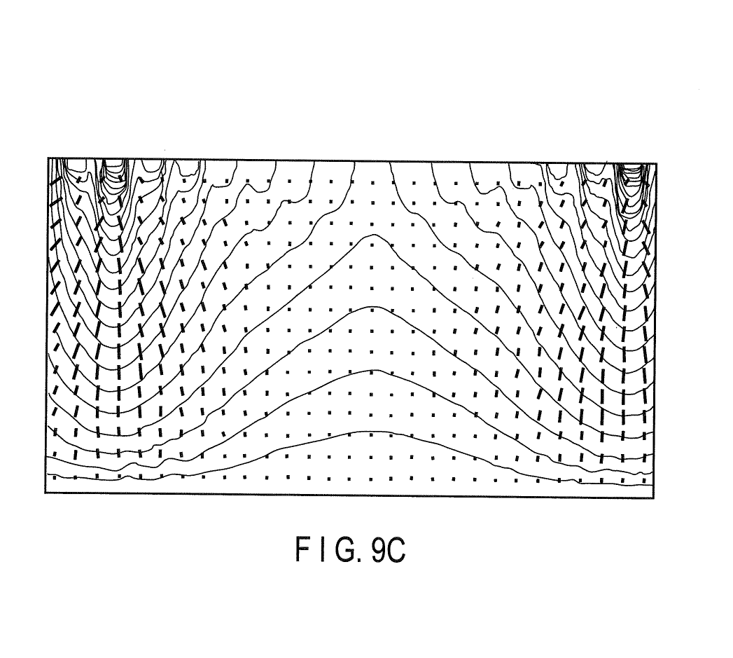

The state and distribution of the liquid crystal directors 107 at the time of 3D display and 2D display when the 3D image display device is used in a vertical position will be described next with reference to FIGS. 9A, 9B, and 9C.

FIG. 9A is a sectional view taken along a line C-C′ in FIG. 4 and a line C″-C′″ in FIG. 2. FIG. 9A is a sectional view of 3D display. Referring to FIG. 1, when the first substrate is cut along a vertical plane including the line C″-C′″, the cut position of the plane on the second substrate corresponds to the line C-C′.

In 2D display, the liquid crystal directors 107 are oriented as shown in FIG. 9B. In this case, an electric field distribution and a liquid crystal director distribution as shown in FIG. 9C are obtained.

A method of performing partial 3D display will be described next with reference to FIGS. 1, 2, 3, 4, and 12.

As shown in FIG. 1, a region of the first substrate 101 where the same voltage is applied to a region in which the first electrodes 103, the second electrodes 104, the fourth electrodes 114, and the fifth electrodes 115 extend in the first direction is divided in the vertical direction along the line A-A′ to do grouping. In FIG. 1, the region is divided into two groups. Grouping is similarly done based on a plurality of types of voltages of the third electrodes 106 on the second substrate 102 located above the region of the first substrate where the same voltage is applied to form a lens.

As shown in FIG. 4, division is done along the line A-A′, and the same type of voltage is applied to a set of a plurality of third electrodes 106 in each of the divided lens array groups. That is, voltage on/off is allowed for all lens arrays in the same group. In FIG. 4, the third electrodes 106 of the same hatching are connected so as to have an equipotential. Reference numerals 401 denote through holes which connect the plurality of third electrodes 106 so that the plurality of connected third electrodes 106 have an equipotential.

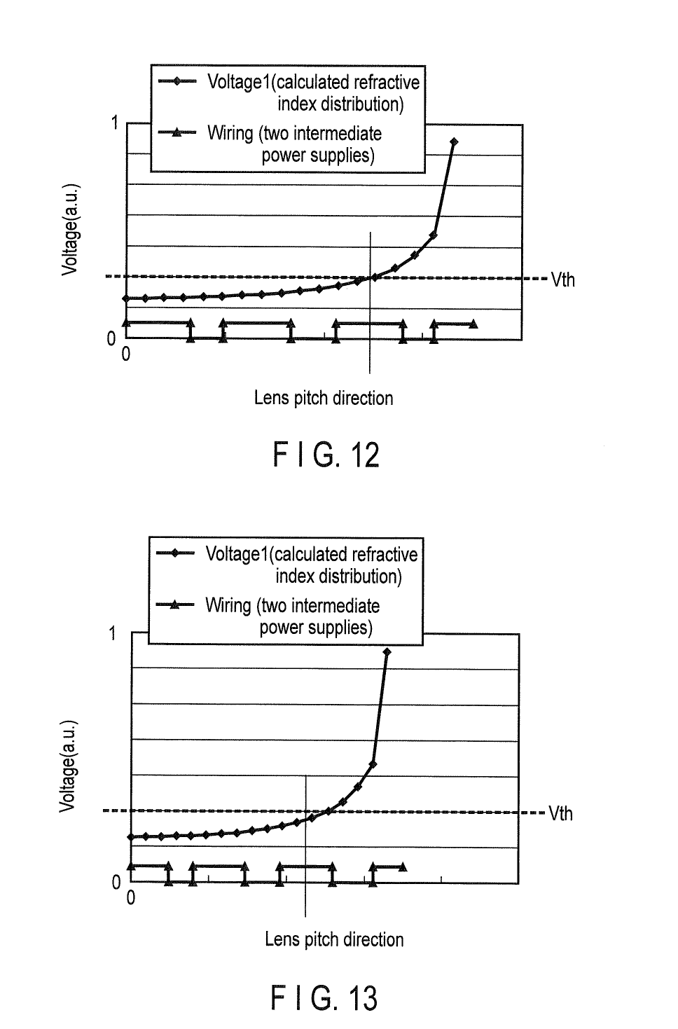

FIG. 12 shows a potential distribution that is a power supply voltage distribution at a position corresponding to one side in a lens, which is obtained by simulation of liquid crystal directors. Note that since the liquid crystal director distribution is not always even in the thickness direction, the ideal voltage distribution changes depending on the liquid crystal thickness.

Positions corresponding to a wiring width and an inter-wiring distance are shown at the lower portion of the graph. Referring to FIG. 12, the second electrode 104 is arranged at the lens center shown on the leftmost side, the first electrode 103 is arranged at the lens end shown on the rightmost side and the fourth electrode 114 and the fifth electrode 115 are arranged between these electrodes.

When a potential corresponding to the position of the wiring center is given to each electrode, a refractive index distribution close to an ideal one can be obtained. As is apparent from FIG. 12, voltages are applied such that almost no potential difference is generated at the lens center, and a high voltage is applied to only the lens end.

In FIG. 1, when (n+1) types of potential distributions are given in the lens, the potentials are defined as Vₙ, Vₙ₋₁, . . . , V₀. Only the first electrodes 103 that are lens end electrodes are led out in the column direction, that is, the first direction, as shown in FIG. 1, and the remaining electrodes are led out in the address direction.

An address power supply group includes n types of power supplies, and a column power supply includes one type of power supply. An appropriate ON or OFF voltage is applied to the address power supply group. An ON or OFF voltage is also applied to the lens end power supply. In the example of FIG. 1, the address power supply group includes the first address electrode voltage supply units 131, the second address electrode voltage supply units 132, the third address electrode voltage supply units 133, and the counter electrode voltage supply unit 135. The column power supply includes the column electrode voltage supply units 134.

When performing partial 3D display by static matrix driving as described above, 2D display needs to be done even in a state in which a voltage is applied within the plane as a necessary condition.

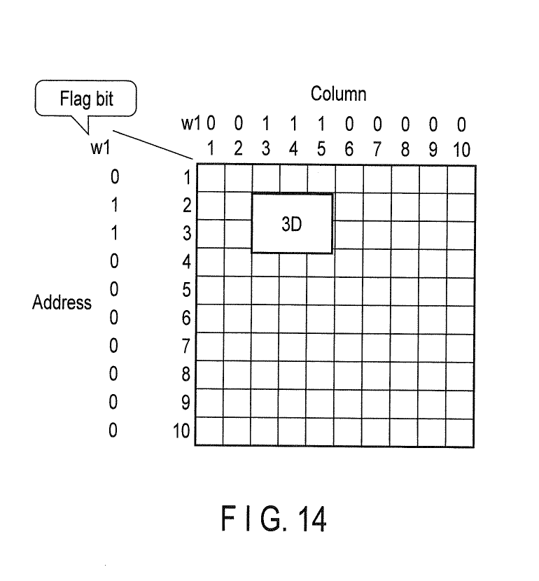

A partial 3D display driving method will be described next with reference to FIG. 14.

Generally, in a simple matrix driving type liquid crystal panel, the contrast lowers as the number of electrode lines increases. A driving method using flag bits is proposed for liquid crystal GRIN lens cells shown in FIG. 14. The flag bits are set to discriminate between the outside and inside of a 3D window. A flag bit “0” or “1” is sent to each of all address lines and column lines. Note that the address lines indicate wirings connected to each address electrode voltage supply unit. Similarly, the column lines indicate wirings connected to each column electrode voltage supply unit. Each of the address lines and column lines only requires two types of different waveforms, that is, ON and OFF voltages. When the flag bits are set to “1” for both an address and a column, a voltage necessary to make the liquid crystal directors rise is obtained, and a 3D display area is formed. Otherwise, the voltage is less than a threshold, and a 2D display area is formed.

When performing flag bit driving, (n+1) types of waveforms from Vₙ to V₀ on the first substrate and one type of waveform of the counter voltage on the second substrate are decided such that satisfactory partial 2D/3D display switching can be done. Additionally, how to distribute the electrodes on the first substrate, to which the (n+1) types of voltages are applied, to the addresses and columns is also decided.

More specifically, the voltages are combined so as to set

Case 1 column ON address ON counter voltage ON 3D display
Case 2 column OFF address ON counter voltage ON 2D display
Case 3 column ON address OFF counter voltage OFF 2D display
Case 4 column OFF address OFF counter voltage OFF 2D display

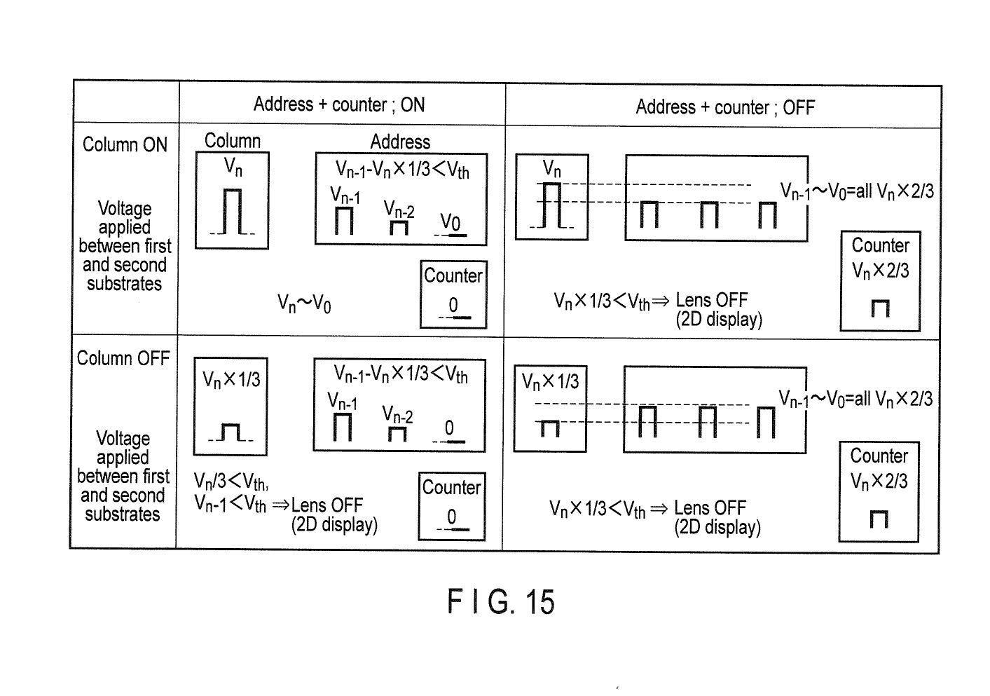

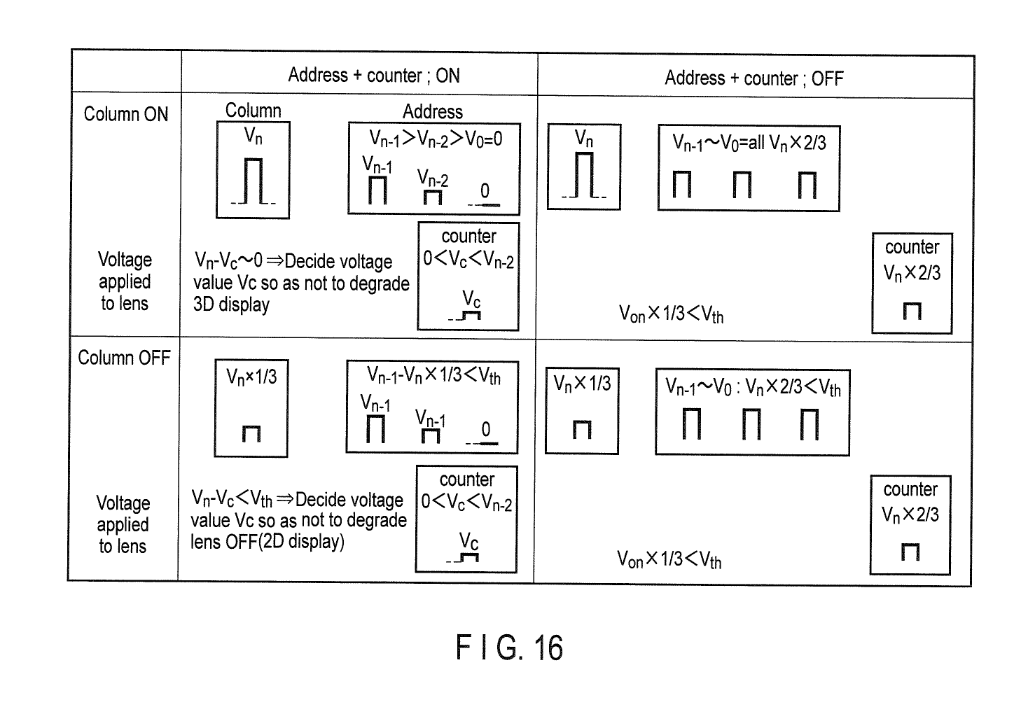

As a derailed example, waveforms of flag bit driving and distribution to addresses and columns will be explained with reference to FIGS. 15 and 16 assuming the case shown in FIG. 5 in which the two types, fourth electrodes 114 and fifth electrodes 115 are disposed between the first electrodes 103 and the second electrode 104.

In case 1, potentials shown in FIG. 12 are applied to the respective electrodes.

For example, a case in which five types of power supply voltages exist as shown in FIG. 1 will be described. The address OFF voltage is used to attain 2D display in case 3 and case 4. Hence, in case 1 and case 2, the following voltages are used.

Case 1 column ON: voltage V₃, address ON: voltages V₂, V₁, and V₀, counter voltage 0 V

Case 2 column OFF: voltage V₃/3, address ON: voltages V₂, V₁, and V₀, counter voltage 0 V

To implement 2D display in case 2, a voltage lower than a voltage Vₜₕ at which the liquid crystal directors begin to rise between the four types of electrodes and the counter substrate is applied.

V₃/3<Vₜₕ

V₂<Vₜₕ

V₁<Vₜₕ

V₀<Vₜₕ

In this case, V₂>V₁>V₀ holds based on FIG. 12. Hence, when

V₃/3<Vₜₕ (3)

V₂<Vₜₕ (4)

are met, 2D display can be implemented. This can be generalized, using (n+1) types of power supplies including the address power supplies and the column power supply, as

Vₙ/3<Vₜₕ (5)

Vₙ₋₁<Vₜₕ (6)

Note that the threshold voltage Vₜₕ at which the liquid crystal rises in bend deformation is given by

$${V}_{th} = π \sqrt{\frac{{K}_{33}}{{ɛ}_{0} {ɛ}_{a}}} \qquad ( 7 )$$

In addition, the threshold voltage at which the liquid crystal rises in bend deformation by Freedericksz transition without twist is given by

$${V}_{th} = π \sqrt{\frac{{K}_{11}}{{ɛ}_{0} {ɛ}_{a}}} \qquad ( 8 )$$

In the liquid crystal GRIN lens, since both the spray deformation and bend deformation of the liquid crystal are involved in some locations, a voltage close to an average voltage may be considered.

In this case, K₁₁ is an elastic constant for spray deformation of the liquid crystal, K₂₂ is an elastic constant for twist deformation of the liquid crystal, and K₃₃ is an elastic constant for bend deformation of the liquid crystal. Additionally, ∈₀ is a dielectric constant in vacuum, and ∈ₐ is dielectric anisotropy (∈ (horizontal) ∈ (vertical)).

In addition, 2D display permits a case in which V_{off} (in the above example, Vₙ/3) is slightly higher than Vₜₕ, and a small lens effect appears to do light condensation.

The voltage distributions in case 3 and case 4 are as follows.

Case 3 column ON: voltage V₃, address OFF: voltages V₂, V₁, and V₀=V₃×⅔, counter voltage V₃×⅔

Case 4 column OFF: voltage V₃/3, address OFF: voltages V₂, V₁, and V₀=V₃×⅔, counter voltage V₃×⅔

In both case 3 and case 4, the potential difference between the column voltage and the address voltage, which are intra-lens voltages, is V₃/3 or less. Hence, like the condition of case 2,

V₃/3<Vₜₕ

suffices. When this is generalized, the condition in case 3 and case 4 is given by

Vₙ/3<Vₜₕ

The lens end power supply voltage is decided by the type and thickness of the liquid crystal and the power supply width, which are optimized to meet inequality (3).

How to distribute V₀, V₁, V₂, and V₃ in the address and column directions decides the quality of 2D display around 3D display in the screen. To form an excellent GRIN lens, when the electrodes are disposed in the lens by dividing the space between them into equal parts based on the widths of the electrodes, the voltages are distributed to the addresses and columns from a boundary where the difference between the voltages applied to two adjacent electrodes of the plurality of electrodes is maximized. In the liquid crystal GRIN lens, a high voltage is necessary to raise the liquid crystal directors at the lens end, as shown in FIG. 12. However, the variation in the refractive index distribution at the lens center is moderate as compared to the lens end. Hence, the voltage at the lens center can be lower than that at the lens end. For this reason, the boundary for distribution to the addresses and columns is located between the lens end and the electrode adjacent to the lens end.

If the boundary for distribution to the addresses and columns is placed between V₂ and V₁, the voltage distributions are as follows.

Case 1B column ON: voltages V₃ and V₂, address ON: voltages V₁ and V₀, counter voltage 0 V

Case 2B column OFF: voltages V₃/3 and V₂/3, address ON: voltages V₁ and V₀, counter voltage 0 V

Case 3B column ON: voltages V₃ and V₂, address OFF: voltages V₁ and V₀=V₃×⅔, counter voltage V₃×⅔

Case 4B column OFF: voltages V₃/3 and V₂/3, address OFF: voltages V₁ and V₀=V₃×⅔, counter voltage V₃×⅔

To implement satisfactory 2D display in case 2B, case 3B, and case 4B, it is necessary to make the potential difference between the column voltage and address voltage and the counter voltage smaller than the threshold voltage and prevent the liquid crystal from rising.

In case 2B, when

V₃/3<Vₜₕ

is met, V₂ is lower than V₃, and therefore, V₂/3<Vₜₕ can be met.

In case 3B, the difference from the counter substrate voltage need only be Vₜₕ or less.

V₃−V₃×⅔=V₃/3<Vₜₕ for V₃, and

V₂−V₃×⅔<Vₜₕ for V₂

are met. When the first expression is met, the second expression is also met because V₂ is almost equal to Vₜₕ from FIG. 12. More specifically, for V₂, V₂−V₃×⅔≈|Vₜₕ−V₃×⅔|. When V₃/3<Vₜₕ, |Vₜₕ−V₃×⅔|<Vₜₕ.

In case 4B,

V₃/3−V₃×⅔=V₃/3<Vₜₕ for V₃, and

V₂/3−V₃×⅔<Vₜₕ for V₂

are met. Since V₂ is almost equal to Vₜₕ from FIG. 12, V₂/3−V₃×⅔≈|Vₜₕ/3−V₃×⅔| for V₂. Even when V₃/3<Vₜₕ, |Vₜₕ/3−V₃×⅔|<Vₜₕ×5/3. Hence, V₂/3−V₃×⅔<Vₜₕ is not always met, and 2D display is difficult in case 4B.

As a characteristic feature of the liquid crystal lens array element according to this embodiment, the distance between the first electrode 103 extending in the first direction and the (n−1)th electrode adjacent to the first electrode 103 extending in the first direction is longer than the distances between other electrodes adjacent to each other and extending in the first direction.

The reason for this is as follows. To meet V₂<Vₜₕ of inequality (4) described above, an ideal refractive index distribution can be obtained when the V₂ electrode adjacent to the V₃ electrode is located closer to the lens center, as shown in FIG. 13, even if the voltage value is small. Assume that the distance between the V₃ electrode and the V₂ electrode is too wide. In this case, when the electrodes on the first substrate 101 function as a ground surface, the voltages of the V₃ and V₂ electrodes are not met as the extension of the ground surface because of the small influence of their potential distribution, and the performance of the lens degrades. The distance between the electrodes needs to be less than at least the thickness of the lens.

When a voltage value ⅓ of the optimum voltage Vₙ applied to the first electrodes 103 is higher than the threshold voltage at which the liquid crystal begins to rise, the counter voltage is set to V_{c}, the voltage of the electrode closest to the lens center is set to V₀, the voltage of the next close electrode is set to V₁, and the voltage to be applied to the lens end is set to Vₙ. Then, a voltage that meets V_{c}≦(V₁−V₀)×0.5 and V_{c}≧Vₙ/3−Vₜₕ is applied to the plurality of third electrodes on the opposing second substrate. The reason for this will be described below.

From inequalities (5) and (6), Vₙ/3 and Vₙ₋₁ need to be lower than Vₜₕ. However, these voltages may be higher than Vₜₕ because of the type of the lens, lens pitch, lens thickness, and the like. When Vₙ₋₁ is high, it can be lowered by locating an electrode corresponding to Vₙ₋₁ at a position slightly close to the inside of the substrate (that is, to the side of the lens center), as described with reference to FIG. 13. Especially, when Vₙ/3 is higher than the threshold voltage in a case in which the lens end power supply voltage is high, lens residue occurs at the time of 2D display.

To prevent this, the counter voltage V_{c} is raised to meet Vₙ/3−V_{c}≦Vₜₕ. By Vₙ/3−V_{c}≦Vₜₕ,

V_{c}≧Vₙ/3−Vₜₕ

preferably holds.

When the counter voltage V_{c} is raised, the voltage differences between the counter voltage and the voltages V₂, V₁, and V₀ change to V₂−V_{c}, V₁−V_{c}, and V₀−V_{c}, respectively. Since V₀=0 V in many cases, V₀−V_{c}=−V_{c} at the lens center. Since V_{c} is a positive value, −V_{c} is a negative potential. When V_{c} equals the value of V₁, the difference from the counter voltage is 0 V at the position of V₁, a negative voltage difference is generated at the lens center, and a positive voltage difference is generated at the lens end. Hence, 2D display degrades. For this reason, when the change in V_{c} is suppressed to be smaller than the intermediate value between V₁ and V₀, the influence of the negative potential difference at the lens center can be made small, and the rise of the liquid crystal at the lens center in an opposite direction can be minimized. As a specific value,

V_{c}≦(V₁−V₀)×0.5

For example, when V₁=0.6 V, and V₀=0 V, V₁−V₀=0.6 V. That is, when address ON and column ON in FIG. 16 are considered, counter voltage V_{c}≦0.3 V.

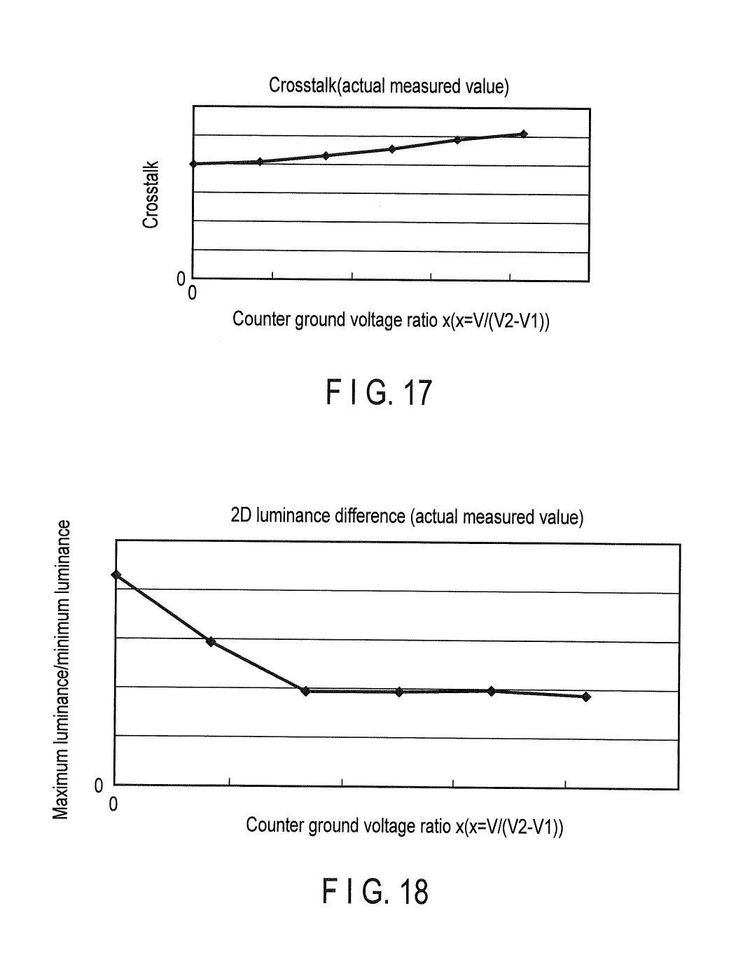

FIG. 17 shows the actual measured value of crosstalk in 3D display obtained by a luminance profile when the counter voltage V_{c} applied to the plurality of third electrodes on the second substrate is set to V_{c}=V₀+x(V₁−V₀) (0≦x≦1) in the voltage table shown in FIG. 16, and one parallax image is displayed.

The crosstalk is defined as follows.

crosstalk=interference luminance/total parallax lightning luminance=(luminance in total parallax lightning−peak luminance of parallax image in front)/total parallax lightning luminance

As is apparent from FIG. 17, as the counter voltage changes from V₀ to V₁, the condensing performance of the lens degrades, and the crosstalk increases.

FIG. 18 shows the maximum value and the minimum value within the viewing angle in 2D display when the counter voltage V_{c} applied to the plurality of third electrodes on the second substrate is set to V_{c}=V₀+x(V₁−V₀) (0≦x≦1) in the voltage table shown in FIG. 16. If the luminance ratio is high, there exists an angle at which a certain element image is invisible, and 2D display degrades. When the counter ground voltage is set to V=V_{c}−V₀, and its ratio (x=V/(V₁−V₀)) with respect to (V₁−V₀) is 0.35 or more, the peak luminance ratio of 2D display is 2, which does not change largely even when the counter voltage is raised. When the peak luminance ratio is 2, a small degradation such as jagged outline in 2D display occurs, but there are no invisible pixels. On the other hand, when (x=V/(V₁−V₀))=0.35, the crosstalk is suppressed with an increase of only 7.5%, as can be seen from FIG. 17.

Since x=0.35<0.5, a condition for preventing degradation of 2D display in partial 2D/3D switching by raising the counter voltage is obtained. In addition, raising the counter voltage only when performing partial 2D/3D switching but keeping the counter voltage at 0 V in full switching is preferable from the viewpoint of crosstalk reduction.

The conditions can be integrated as

Case 2 column OFF: voltage V₃/3, address ON: voltages V₂, V₁, and V₀, counter voltage V_{c}≦(V₁−V₀)×0.5, and V_{c}≧Vₙ/3−Vₜₕ

Use of an orientation switching naked eye display will be described next.

A liquid crystal GRIN lens has no lens shape when no voltage is applied. The liquid crystal GRIN lens generates a gradient distribution of liquid crystal directors and forms a refractive index distribution by an electric field distribution. Hence, a vertical lens and a horizontal lens can be formed by an electrode structure. To reduce cost and weight, one liquid crystal GRIN lens is preferably commonly used for both. Several conditions are needed to use a liquid crystal GRIN lens as a transparent substrate display orientation switching lens.

To use the liquid crystal GRIN lens as both a vertical lens and a horizontal lens, when a desired voltage is applied to the upper electrodes, all the lower electrodes are connected to the reference potential (normally, ground potential). When a desired voltage is applied to the lower electrodes, all the upper electrodes are connected to the reference potential. To form a smooth lens shape, a smooth electric field distribution needs to be formed. On the other hand, the electrodes are arranged all over the substrate and wholly connected to the ground of the circuit, thereby forming a pseudo ground surface. If the ground surface includes a portion where no metal surface exists, a portion to which no electric field is applied exists, and a discontinuous portion is formed in the electric field distribution. When the gap is narrowed, it can be regarded as the ground surface because of the influence of a neighboring ground electrode. As described above, both the upper and lower electrodes need to function as the power supply surface and the ground surface.

The electrode arrangement and driving method of a liquid crystal GRIN lens capable of performing orientation switching and partial 3D display in FIG. 1 have been described above.

According to the above-described first embodiment, the 3D image display device can perform naked eye 3D display in the landscape direction and portrait direction. In the landscape direction, 3D display can be performed partially, and 2D display can be maintained in the other region.

### Second Embodiment

In a vertical lens, the black matrix of a normal parallax image display LCD and the lens expansion direction are parallel. For this reason, a light and dark pattern like white and black stripes called moiré is observed depending on the parallax direction, resulting in display degradation. To prevent moiré, it is necessary to take some measure for the black matrix of the parallax image display LCD. On the other hand, even when a normal LCD is used, moiré can be prevented by an oblique lens having a lens ridge line tilted in an oblique direction.

In the oblique lens, the first direction of first electrodes has an angle with respect to the vertical direction of the display. Hence, partial 3D display has not a rectangular shape but a parallelogram or tilted rectangular shape, resulting in poor usability.

To prevent this, the first direction in which the first electrodes and second electrode extend is set obliquely, and the liquid crystal orientation direction is set obliquely to be perpendicular to the first direction.

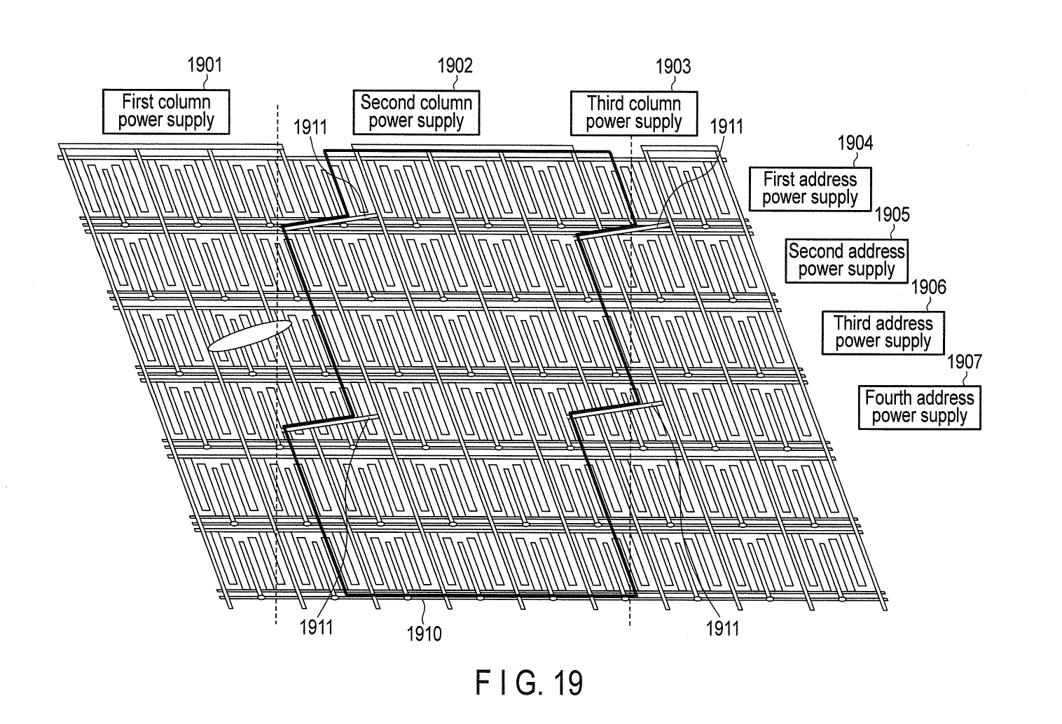

A liquid crystal lens array element according to this embodiment will be described with reference to FIG. 19. FIG. 19 is a perspective plan view showing the liquid crystal lens array element according to this embodiment viewed from a direction perpendicular to the substrate.

In the liquid crystal lens array element according to this embodiment, as compared to the liquid crystal lens array element described in the above first embodiment, in the first embodiment in which the angle of the first direction with respect to the second direction is different when viewed from the upper surface, the first direction is perpendicular to the second direction. In this embodiment, however, the first direction is not perpendicular to the second direction but is tilted.

As shown in FIG. 19, in this embodiment, the second direction is the same as the second direction in the above-described first embodiment. More specifically, second extraction electrodes 105 according to this embodiment extend in the horizontal direction, as in the above-described first embodiment.

On a first substrate, when a plurality of first electrodes, second electrodes, and nth electrodes are electrically connected to form groups, and the first direction is tilted obliquely with respect to the vertical direction of the display, the bar-like first electrodes are cut left and right in correspondence with the resolution of partial 3D display in parallel to the vertical direction of the display. Adjacent first electrodes in the same region are connected to each other at the lens ends, and the same voltage is turned on/off.

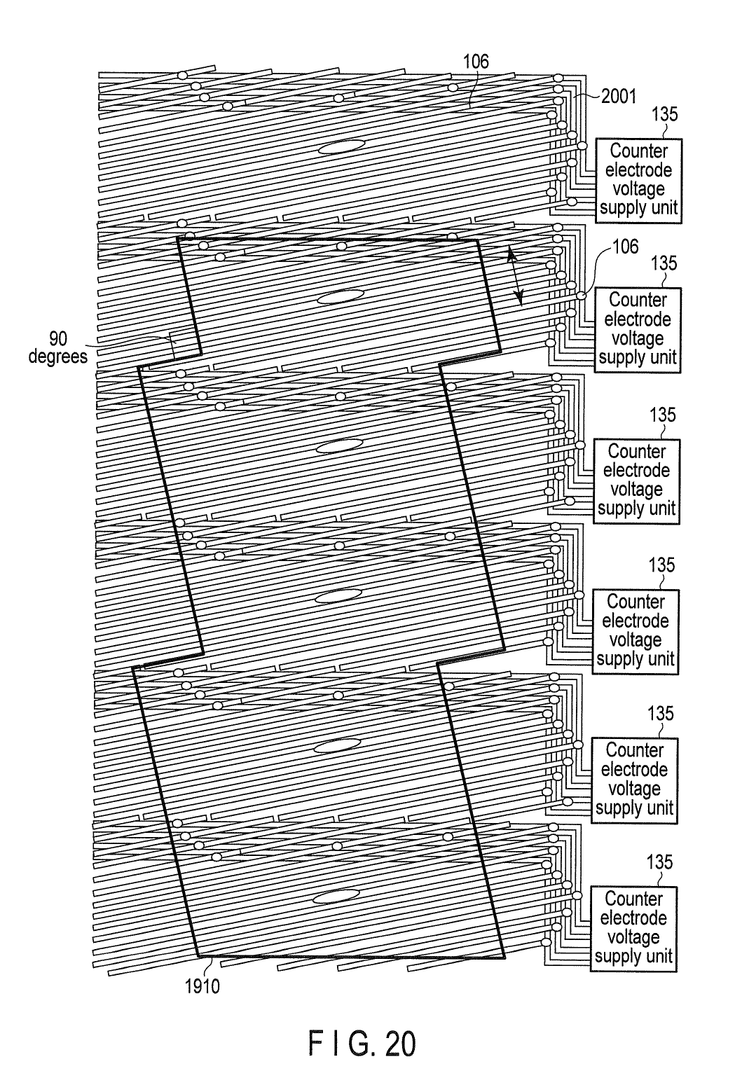

As shown in FIG. 20, the extending direction of third electrodes 106 is defined as a third direction perpendicular to the first direction. The third direction is also obliquely set. The third electrodes in the second substrate above the first substrate extend in a direction almost perpendicular to the first direction.

On the second substrate, when the plurality of third electrodes that form lenses are electrically connected to form groups, and the third direction is tilted obliquely with respect to the horizontal direction of the display, the bar-like third electrodes are cut vertically by the resolution of partial 3D display in parallel with the horizontal direction of the display. The third electrodes in the same region located at the same position of adjacent lenses are connected to each other at the lens ends, and the same voltage is turned on/off.

In this embodiment, the longitudinal direction of each cylindrical lens of a lens array can be arranged not to be perpendicular to the second direction. As a result, the longitudinal direction of the cylindrical lens can be tilted with respect to the pixel array direction of a 2D image display device 110. This is because in the normal 2D image display device 110, the pixels are arrayed in the horizontal direction and the vertical direction that is perpendicular to the horizontal direction. This tilted arrangement can reduce luminance moiré and color moiré derived from the cylindrical lenses and pixels and improve the display quality.

Additionally in this embodiment, the pixel array direction of the 2D image display device 110, particularly, the horizontal direction and the above-described second direction can be matched. The reason for this is as follows. Place focus on the boundary line between 2D display and 3D display when partial 3D display is implemented. Since the cut portions of the third electrodes 106 in FIG. 20 are arranged in the horizontal direction, the boundary in the vertical direction can be the horizontal direction.

The first direction is arranged obliquely with respect to the vertical direction to reduce moiré. As shown in FIG. 19, first electrodes 103 are divided left and right based on the positions of dotted lines drawn in the vertical direction. Precisely speaking, the plurality of first electrodes 103 are divided left and right by two left and right boundary lines extending not in the horizontal direction out of the boundary lines of a partial 3D display region 1910 in FIG. 19. In the divided region, that is, in the partial 3D display region 1910, a voltage is supplied from a single column electrode voltage supply unit 134. In the example of FIG. 19, a second column power supply 1902 applies a voltage to the first electrodes 103 in the partial 3D display region 1910 so that the first electrodes 103 in this region are set at an equipotential. In other words, the first electrodes 103 near the boundary of the region are connected by first wiring end connection portions 1911 such that the first electrodes 103 in the divided region attain an equipotential. Each of column power supplies 1901 to 1903 corresponds to the column electrode voltage supply unit 134. Each of address power supplies 1904 to 1907 includes a first address electrode voltage supply unit 131, a second address electrode voltage supply unit 132, and a third address electrode voltage supply unit 133.

Normally, the in-plane wirings of third electrodes 106 extend in the third direction. The third direction is almost perpendicular to the first direction that is tilted with respect to the vertical direction in FIG. 19. The initial orientation direction of a liquid crystal on a second substrate 102 is preferably parallel to the extending direction of the third electrodes on the second substrate, as shown in FIG. 20. A plurality of types of power supply voltages are applied to the third electrodes 106, and such arrangement is repeated for every lens pitch. For this reason, as shown in FIG. 20, third extraction electrodes 2001 of the plurality of types of power supply voltages from each counter electrode voltage supply unit 135 are arranged using the third electrodes 106 between the second substrate 102 shown in FIG. 20 and, for example, the insulator (not illustrated in FIG. 1) of a dielectric 108. In the same way as described above, horizontal lines are drawn to cut the same region as the region divided by the groups on a first substrate 101, and the wirings are cut to upper and lower sides. The same voltage region is divided into a plurality of regions in the vertical direction, and a plurality of types of power supply voltages are similarly supplied by the leader lines up to the display ends in the horizontal direction.

According to the above-described second embodiment, when partial 3D display is performed by an arrangement of a landscape naked eye display lens array group including electrodes extending in the vertical direction and a portrait naked eye display lens array group including electrodes extending in the horizontal direction, an almost rectangular window display can be formed. In general, partial 3D display often requires rectangular window display. Hence, this embodiment can meet the requirement of an almost rectangular window display.

Other aspects of the configuration, operation, and effect of this embodiment are the same as in the above-described first embodiment.

### Third Embodiment

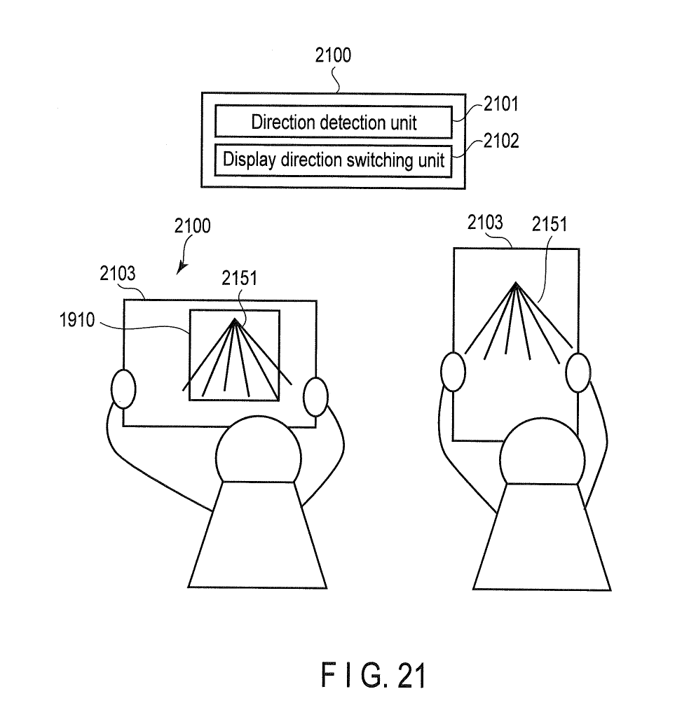

A 3D image display device 2100 including a liquid crystal lens array element described in the above embodiment will be explained with reference to FIG. 21.

The 3D image display device 2100 includes a direction detection unit 2101, a display direction switching unit 2102, and an orientation switching naked eye display unit 2103.

The direction detection unit 2101 detects the landscape direction or portrait direction in which the user is viewing the 3D image display device 2100. The direction detection unit 2101 detects the direction in which the user is viewing using, for example, an acceleration sensor. The left part of FIG. 21 indicates that the 3D image display device 2100 is set in the landscape direction, and the right part of FIG. 21 indicates that the 3D image display device 2100 is set in the portrait direction.

The display direction switching unit 2102 switches the direction of an image to be displayed on the orientation switching naked eye display unit 2103 in accordance with the direction detected by the direction detection unit 2101.

The orientation switching naked eye display unit 2103 can partially display a 3D image when the device is set in the landscape direction. The partial 3D image is displayed in a partial 3D display region 1910, and parallax light beams 2151 are emitted from the partial 3D display region 1910.

Even when the user is viewing the device set in the portrait direction, the orientation switching naked eye display unit 2103 emits the parallax light beams 2151 when a 3D image is being displayed.

According to the above-described third embodiment, an image can be switched in an appropriate direction by detecting the landscape direction or portrait direction in which the user is viewing the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A gradient index liquid crystal optical device comprising:
a first substrate;
a second substrate arranged to face the first substrate;
a liquid crystal layer sandwiched between the first substrate and the second substrate;
a plurality of first electrodes provided on the first substrate on a side of the liquid crystal layer and extending in a first direction;
a plurality of second electrodes arranged between the first electrodes and extending in the first direction;
a third electrode provided on the second substrate on the side of the liquid crystal layer and extending in a third direction different from the first direction; and
a plurality of fourth electrodes arranged between the first electrodes and the second electrodes and extending in the first direction,
wherein the second electrodes adjacent in a second direction different from the first direction are electrically connected, and the fourth electrodes adjacent in the second direction are electrically connected.

2. The device according to claim 1, further comprising:
a second extraction electrode configured to electrically connect the second electrodes adjacent in the second direction; and
a fourth extraction electrode configured to electrically connect the fourth electrodes adjacent in the second direction.

3. The device according to claim 2, further comprising:
a second voltage supply unit configured to supply a second voltage to the second extraction electrode; and
a fourth voltage supply unit configured to supply a fourth voltage different from the second voltage to the fourth extraction electrode.

4. The device according to claim 1, wherein the first electrodes are electrically connected together to form a group.

5. The device according to claim 1, wherein the third electrode extends in the third direction perpendicular to the first direction, and third electrode each corresponding to the same position for each lens unit is electrically connected to each other.

6. The device according to claim 1, wherein the liquid crystal layer is made of a uniaxial liquid crystal and a direction parallel to the third direction is an orientation direction of liquid crystal directors.

7. The device according to claim 1, further comprising a plurality of (n+1)th electrodes arranged between the first electrode and the nth electrode and extending in the first direction,
wherein n is a number of not less than 4, and when n is not less than 5, the gradient index liquid crystal optical device comprises fifth to (n+1)th electrodes.

8. The device according to claim 7, a distance between the first electrode and the (n+1)th electrode closest to the first electrode is longer than a distance between the (n+1)th electrode and the nth electrode located, on a side of the second electrode closest to the (n+1)th electrode.

9. The device according to claim 1, a distance between the first electrode and the fourth electrode closest to the first electrode is longer than a distance between the fourth electrode and a fifth electrode located, on a side of the second electrode closest to the fourth electrode.

10. The device according to claim 1, a voltage applied between each of the fourth electrodes and the third electrode facing the each of fourth electrodes is lower than a threshold voltage at which a liquid crystal begins to rise.

11. The device according to claim 1, a voltage value ⅓ of a voltage applied to the first electrodes is smaller than a threshold voltage value at which a liquid crystal begins to rise.

12. The device according to claim 1, when a voltage value ⅓ of a voltage applied to the first electrodes is not less than a threshold voltage value at which a liquid crystal begins to rise, a voltage having a voltage value V_{c} is applied to the third electrode, the voltage value V_{c} meeting
V_{c}≦(V₁−V₀)×0.5 and V_{c}≧Vₙ/3−Vₜₕ
where V_{c} is the voltage value of the third electrode facing the first electrode, V₀ is a voltage of an electrode closest to a lens center, V₁ is a voltage of an electrode second closest to the lens center, and Vₙ is a voltage applied to a lens end.

13. The device according to claim 1, the second direction is not perpendicular to the first direction.

14. The device according to claim 13, each of the first electrodes further comprises a connection portion configured to connect the adjacent first electrodes to make a shape close to a rectangle have an equal position voltage.

15. The device according to claim 13, the third direction is perpendicular to the first direction.

16. The device according to claim 15, third electrode each corresponding to the same position for each lens unit is electrically connected to each other.

17. The device according to claim 1, the first electrodes, the second electrodes, and the fourth electrodes are repetitively arranged in an order named along the second direction.

18. An image display device comprising:
the gradient index liquid crystal optical device according to claim 1; and
an image display unit.
